(19) United States
(12) Patent Application Publication
(10) Pub. No.: US 2012/0201995 A1
(43) Pub. Date: Aug. 9, 2012

(54) Moulded body having cladding material and carrier material and method for the production thereof

(76) Inventors: Jürgen Melle, Rudolstadt (DE); Ralf-Uwe Bauer, Rudolstadt (DE); Frank-Günter Niemz, Rudolstadt (DE); Sabine Riede, Uhlstadt-Kirchhasel (DE)

(21) Appl. No.: 13/498,282

(22) PCT Filed: Sep. 14, 2010
(86) PCT No.: PCT/EP10/05621

§ 371 Date: Mar. 26, 2012

(30) Foreign Application Priority Data
Sep. 30, 2009 (DE) 10 2009 043 463.1

(51) Int. Cl. B32B 3/02; B05D 3/00; B05D 1/26; B05D 3/02

(52) U.S. Cl. 428/68; 427/385.5; 427/299; 427/209

(57) ABSTRACT

The invention relates to a molded body having a polymeric coating in which cladding material is prepared from a polymer solution; carrier material is guided through a feed channel and an outlet opening into a coating chamber, the feed channel traversing a container holding the cladding material; the cladding material is guided through a predefined gap into the coating chamber, and contact is effected between the cladding material and the carrier material to form a preliminary layer; the carrier material and preliminary layer are guided through an outlet opening into a relaxation zone; by setting the withdrawal of the carrier material via the outlet opening into the relaxation zone, the cladding material, the carrier material or both can be altered; and solvent is removed from the polymer layer. The molded bodies are preferably fibers, in particular bristles, such as brush or paint brush bristles.

The invention relates to a shaped article comprising a carrier material and at least one polymer-containing sheath material, especially fibers or filaments, for example for brushes or bristles. The invention further relates to a process for producing the shaped article comprising coating a carrier material.

The production of polymer-containing layers, of cellulose for example, on different carrier materials is known per se. The initial processes for producing formable cellulosic polymeric dopes form the basis for proposals to generate sheathings of cellulose on different shaped articles.

DE 524929 proposed producing strings by impregnating threads of differing origin with viscose solutions and then regenerating the cellulose. The regenerated cellulose serves as binder between individual threads as well as to create a smooth outer surface on the strings, which thus have improved processing properties.

DE 557554 proposes the production of particularly strong artificial threads. A core thread of high breaking strength is sheathed with a layer of cellulose which may be formed from viscose, cellulose/copper oxide ammonia solution or acetate spinning solution.

None of the abovementioned processes addresses the use of cellulose solutions produced in a direct dissolving process, none of these processes utilizes the relaxation behavior of such solutions to produce particularly strong, uniform and adjustable coatings which may incorporate a particularly high proportion of addition agents.

GB 559943 proposes inter alia using cellulose derivatives in dissolved form as adhesives to fix abrasive particles to paper, wherein coating is effected in three successive steps of first applying a cellulose derivative layer as adhesive, then the abrasive particles are disbursed and consolidated with a final layer of cellulose derivative. It thus takes three process steps to attach this layer of abrasive particles to the surface of a carrier.

The production of cellulose sponge cloths with internal reinforcement in the form of fibers or fiber meshes is reviewed in WO 99/27835. The lyocell process is proposed for producing the formable solution of cellulose. The production of uniform functional layers of defined thickness is not derivable from this process because the cellulose solution is spread out either on a transportation belt or on a polymeric mesh, and this is significantly different than the process proposed hereinbelow. Existing processes are predominantly used to produce thin layers or thin filaments from formable polymers. These are only marginally useful, if at all, as carrier material for addition agents as needed for example for industrial specialty applications or for sanding, cleaning or reconditioning purposes. Depending on the proportion and particle size of additives present and also depending on the filament diameter, the polymer network of the shape-forming polymer is increasingly disrupted whence a decrease for example in the physical textile properties of fibers and filaments results and/or spinning these solutions is not possible. The proportion and particle size of additives present can also affect machine components, for example by leading to abrasion on the valves and pump components.

It is an object of the present invention to avoid the disadvantages of what is known and to make available a process for producing shaped articles having a polymeric coating. The purpose was to provide a product where the diameter and/or the layer thickness of the shaped article are uniform and choosable, and where the polymer layers are suitable for incorporation of selected addition agents. The shaped article shall also have reinforcing properties, especially a high strength, even with major proportions of functional additives. The shape of the carrier material shall be capable of variation and/or the layer thicknesses of the coating shall be uniform and choosable, while the coating is suitable for firmly attaching functional addition agents even in large amounts. At the same time, the process shall ensure gentle processing of the sheath material using only very low shearing forces in the case of sensitive addition agents which are easily destroyed themselves, as with the incorporation of capsules laden with liquid active ingredient or in the case of addition agents which can have a damaging effect on the polymer solution, as is the case with conductivity carbon black or activated carbon. The coating shall not impair the properties of the carrier material. A bond of high strength shall form between the carrier material and the coating. More particularly, this process shall enable the production of coatings having firmly anchored abrasive particles, even of comparatively large particle diameter.

The process for producing a shaped article having a polymeric coating comprises producing a sheath material from a polymer solution by dissolving of polymers in a solvent in the direct dissolving process and said sheath material meets a carrier material in the coating space, where said sheath material and said carrier material come into contact to form on said carrier material a provisional layer of sheath material by forced wetting in a variable pressure and flow equilibrium within the coating space, and the carrier material together with said layer then passes through a relaxation sector of defined length enabling alignment of the polymers and viscoelastic relaxation and forming a final low-stress polymeric solution layer, the sheath material being additionally deformable by adjusting the withdrawal of said carrier material from said coating space via an exit opening into said relaxation sector, and finally removing the solvent from the polymeric solution layer.

In the present invention process for producing a shaped article, a coating or sheath material is produced from a polymer solution by dissolving polymers in a solvent in the direct dissolving process and fed into a stock reservoir container. A carrier material is fed at defined speed through a feed channel and through an opening into a coating space, wherein the feed channel transverses the container containing the sheath material. At the same time, the sheath material is fed through a predefined gap and at predefined pressure into the coating space where the sheath material and the carrier material come into contact for the first time and thereafter the carrier material, conjointly with the adhering sheath material, is fed through a further exit opening and passes through a relaxation sector of defined, more particularly variable, length. Due to adjusting the carrier material's speed, the sheath material's pressure and viscosity, size of gap wherethrough the sheath material meets the carrier, size of gap wherethrough the carrier material leaves the coating space together with the adhering sheath material and due to relaxation sector length, a defined layer is produced. Sector length is chosen such that, owing to the polymer solution being viscoelastic, a relaxation takes place only for a firm interconnection of ultimate layer thickness to the carrier material to form on removing the solvent.

Finally, the solvent is removed from the polymeric solution layer.

A direct dissolving process is a dissolving process in which the polymer is dissolved in a solvent directly and without chemical derivatization or transformation.

Sheath material in the present application is to be understood as meaning material which is or becomes a coating on the carrier material.

The coating can envelop the carrier material completely or partially and is in direct contact with the carrier material.

Preferably, relaxation sector length is set in a further step of the process. Relaxation sector length is more particularly at least 0.5 cm. Sector length is chosen such that the polymeric constituents of sheath material solution relax, i.e., become stresslessly aligned alongside the carrier material, only to form a strong ultimate interbond around and with the carrier material after dissolving out the solvent.

The withdrawal of the carrier material from the coating space (19, 19′), the subsequent relaxation sector (40) and the at least partially effected precipitation of sheath layer polymers provide the formability, especially the jet stretch ratio of the polymeric sheath material to form the final polymeric solution layer.

The relaxation sector is preferably under normal ambient conditions. The coated carrier material thus passes through an air sector under atmospheric pressure. Alternatively, the ambient conditions can also be rendered via temperature, pressure and atmospheric composition such that sheath layer relaxation on the carrier material is favored and more particularly accelerated.

Alternatively, there can be an underpressure, or the shaped article can be subjected to the flow of a certain gas. A further possibility is to air condition the relaxation sector, for example by setting a temperature and/or humidity.

In a preferred embodiment of the process according to the present invention, the sheath material is pressurized in the container.

The problem is further solved by a process for producing a shaped article, in particular as described above, wherein a polymer solution, especially a cellulose solution, is fed to an exit opening under elevated pressure compared with ambient pressure and is relaxed there in ambient conditions.

The pressure can be generated via a metering pump.

However, preference is given to using a gas pressure or a piston. This is particularly advantageous when the starting material contains a functional additive, in particular abrasive agents, of comparatively large diameters or comparatively large amount. Addition agents of this type could have a disadvantageous effect on the working of a metering pump.

The pressure is preferably generated by pressurizing the starting material with an inert gas, for example nitrogen. Nitrogen inhibits possible degradation reactions on thermal storage especially when additional additives are present. The pressurized gas atmosphere should not contain any moisture, since this would impair the dissolved state of cellulose solution for example.

The polymer solution is preferably put under an elevated pressure between 0.1 bar and 50 bar and preferably between 0.3 bar and 6 bar relative to the ambient pressure.

The pressure to be chosen to pressurize the polymer solution or spinning dope results from the composition of the spinning dope itself and the flow behavior resulting therefrom and the finally desired thickness of sheath layer at a defined carrier material speed. For example, uniform discharge of the solution requires higher pressure with increasing polymer content of the solution. The same holds for increasing withdrawal speeds. Preferred pressures amount to about 0.1 bar to 10 bar. For instance, 0.3 bar is suitable for a coating solution having a cellulose content of 4% by weight and 6 bar for a cellulose content of 12% by weight and withdrawal speeds of up to 60 m/min. Higher pressure up to about 50 bar makes significantly higher withdrawal speeds possible.

Pressure can be post regulated to obtain a consistent quality of shaped part or coating. This will also ensure a constant exit speed as the mass in the coating device decreases.

In an advantageous embodiment of the process according to the invention, a specifically filamentary core composed of a carrier material is coated with at least one sheath material.

The carrier material can be removed in a further operation to produce a hollow article.

In one particular embodiment, the carrier material and/or at least one sheath material contain predominantly (more than 50% by weight of) cellulose.

Coaxial, not only concentric but also eccentric, layer formation on carrier materials, especially of round cross section, for example mono- or multifilaments and yarns may be used to apply a shrinkage crimp to these shaped articles.

In one preferable embodiment of the process according to the present invention, a core of carrier material is fed continuously at defined speed to a coating space, is contacted therein with a sheath material which is under elevated pressure compared with the ambient pressure and the pressure of which is adjusted as a function of the composition and viscosity of the sheath material, and is subsequently fed through an exit opening of adjustable size and relaxed in ambient conditions.

Sheath layers of consistent thickness and quality are obtained in this way. Sheath layer thickness can vary within wide limits. It is adjusted as a function of the use intended for the coated shaped articles and is influenced by the sheath solution composition, especially the size of addition agents. The thickness is generally in the range from 200 nanometers to 5.0 millimeters. Preferred ranges are between 1 to 800 μm, more preferably to 600 μm, especially 10 to 500 μm and very specifically 20 to 400 μm, depending on intended use.

The phase boundary between the core material and the sheath material is particularly well developed owing to the coating process. The shaped articles of the present invention can as a result of this as well as other reasons be distinguished from coextruded shaped articles where the core material is also extruded in the form of a solution.

The polymer solution can be produced using directly soluble natural, synthetic or biotechnologically produced polymers. Directly soluble polymers are polymers capable of dissolving directly, without chemical derivatization.

Suitable polymers are for example natural polymers such as polysaccharides, e.g. cellulose, chitosan, starch; synthetic polymers such as polyacrylic acid, poly-acrylamide, polyvinyl alcohol, polyacrylonitrile, poly-styrenes, polymethyl methacrylate, polyesters, poly-amides, polyimides; or biopolymers such as polylactides, proteins such as silk, fibroins, biotechnologically produced polyesters or polyamides.

Cellulose solution is preferably used to produce the shaped article. It is particularly preferable for the cellulose solution to be obtained in the direct dissolving process in N-methylmorpholine N-oxide or in ionic liquids without derivatization, i.e., in the so-called “Lyocell” process. Shaped articles produced using cellulose solutions are notable for particularly good adherence of the sheath layer to the carrier material and/or for a particularly high possible content of addition agents.

Suitable solvents for dissolving polymers are polar solvents such as for example water, alcohol, acetone, acetonitrile, dimethyl sulfoxide, glycerol, salts such as LiCl, sodium thiocyanate, acids, for example acetic acids, ammonia, ionic liquids; organic solvents such as dimethylformamide, dimethylacetamide, N-methyl-pyrrolidone, apolar solvents, such as short-chain hydrocarbons, for example petroleum, ether. Suitable tertiary amine oxides are for example NMMNO, suitable ionic liquids are for example alkylimidazolium chlorides or acetates or nitrates.

Additives may be added during the dissolving process to modify the resultant polymer solution such that the additives are in a homogeneous uniform distribution as they are translated into the solution state and transition onto the shaped article, especially onto the sheath layer, in the following forming and coagulation step.

In one embodiment of the process, the polymeric or especially cellulose solution is thoroughly mixed with the functional additive, by stirring for example, before the forming step to ensure homogeneous dispersion of the functional additive.

The functional additive is chosen such that it specifically influences at least one of the following properties of the shaped article: tensile strength, flexural strength, stiffness, wear resistance, abrasivity, surface roughness, liquid imbibition capacity, friction behavior, electrical conductivity; odor, color, flame control, barrier formation, perviousness, especially of gases and/or liquids, and/or stability, especially with regard to external influences in certain uses, for example weather stability, stability to radiation, such as UV radiation, chemical stability, stability to mechanical agencies, thermal stability, such as stability to heat and cold, fire resistance. The functional additive is preferably a member of the group of agents used for industrial specialty applications, such as sanding, cleaning or care purposes. These include for example abrasives, such as carbides, corundums, metal oxides, diamond powder, cubic boron nitride (CBN) or hard metal. Functional additives also include fats, oils, such as paraffin, scents, minerals, friction-reducing pigments, such as Teflon, molybdenum sulfide or graphite, color pigments, such as TiO₂, but also ion exchangers, absorbers (such as for example bentonites or modified bentonites, activated carbon, zeolites), pure silver, superabsorbents, PCM (phase change materials), hydrophobic/hydrophilic modifiers, insect repellants, UV absorbers, thermochromic/electrochromic substances, surface-active agents, dispersants, pore-forming agents, foam formation inhibitors (for example silicone-containing compounds and fluorinated compounds), antioxidants (for example sterically hindered phenols and phosphites), thermal stabilizers (for example phosphites, organophosphorus compounds, metal salts of organic carboxylic acids and phenol compounds), light or UV stabilizers (for example sterically hindered hydroxybenzoates and sterically hindered amines), microwave-absorbing additions (for example multifunctional primary alcohols, glycerols and carbon), reinforcing fibers (for example carbon fibers, aramid fibers and glass fibers), conductive fibers or particles (for example graphite or activated fibers or particles of carbon, conductivity carbon black or metals), lubricants, processing aids (for example metal salts of fatty acids, fatty acid esters, fatty acid ethers, fatty acid amides, sulfonamides, polysiloxanes, organophosphorus compounds, silicon-containing compounds, fluorinated compounds and phenol polyethers), flame retardants (for example halogenated compounds, phosphorus compounds, organic phosphates, organic bromides, aluminum oxide trihydrate, melamine derivatives, magnesium hydroxide, antimony compounds, antimony oxide and boron compounds), antiblocking additions (for example argillaceous earth, talc, zeolites, metal carbonates and organic polymers), anti-fogging additions (for example nonionogenic surface-active chemicals, such as glycerol esters, polyglycerol esters, sorbitan esters and their ethoxylates, nonyl-phenyl ethoxylates and alcohol ethoxylates), antistats (for example nonionogenic antistats, for example fatty acid esters, ethoxylated alkylamines, diethanolamides and ethoxylated alcohol; anionic antistats, for example alkyl sulfonates and alkyl phosphates; cationic antistats, for example metal salts of chlorides, methosulfates or nitrates, and quaternary ammonium compounds; and amphoterics such as for example alkylbetaines), antimicrobials (for example arsenic compounds, sulfur, copper compounds, isothiazoline-phthalamides, carbamates, inorganics based on silver, silver-zinc zeolites, silver-copper zeolites, silver zeolites, metal oxides and silicates), cross-linking elements or agents for controlled degradation (for example peroxides, azo compounds, silanes, isocyanates and epoxy resins), dyes, pigments, colorants, fluorescent brighteners or optical brighteners (for example bisbenzoxazoles, phenylcoumarins and bis(styryl)biphenyls), fillers (for example natural minerals and metals such as for example oxides, hydroxides, carbonates, sulfates and silicates; talc; clay; wollastonite; graphite; carbon black; carbon fibers; glass fibers and beads; ceramic fibers and beads; metal fibers and balls; fine powder varieties; and fibers of natural or synthetic origin such as for example fibers of wood, starch or cellulose fine powder species), bonding agents (for example silanes, titanates, zirconates, fatty acid salts, anhydrites, epoxy resins and unsaturated polymeric acids), reinforcing agents, crystallization or crystallization nucleus formation agents (for example any desired construction material which increases or improves the crystallinity of a polymer, for example to improve the rate or kinetics of crystal growth, the number of grown crystals or the species of grown crystals), etc.

The adding of functional additives provides composite materials of construction that have properties/combinations of properties that are unattainable using conventional coating processes such as spraying, adhering or dipping. In addition, even “labile” polymer solutions having very high extraneous contents of up to 95% by weight, based on the polymer, or containing extraneous ingredients having comparatively large particle sizes up to 3 mm are processable.

The functional additive is preferably an abrasive, care and/or scent agent. The functional additive, which is selected from the abovementioned groups in particular, is preferably dispersed in particle or droplet form in a polymer-containing starting material when the latter is still in liquid, pasty or granular form, preferably before it was converted into the dissolved state.

The droplet or corpuscle size of the functional additive is generally in the range from 1 nanometer to 3 millimeters. Size here is to be understood as meaning a largest diameter of the corpuscle or droplet.

The droplet or corpuscle size of the functional additives added depends on the species of additives added and on the intended use. This process may preferably utilize abrasive, conductive, absorbing functional additives/capsules containing encapsulated active ingredients. These additives can be used singly or combined or else together with further functional additions such as antibacterial, flame-retardant, scent or dye chemicals.

Abrasive functional additives preferably have an average size of 1 μm to 3 mm. They are preferably embedded in a coating having a thickness up to 5 mm. The proportion of abrasive additives can be up to 95% by weight, based on the total weight of the coating. When silicon carbide or corundum is chosen as abrasive additive, the average particle size thereof is preferably in the range from 1.2 μm to 3 mm. The proportion in the coating is preferably up to 35% by weight, based on the total weight of the coating. Cubic boron nitride (CBN) preferably has an average particle size of 1 μm to 1.0 mm, the layer thickness is preferably up to 3 mm, the CBN content of the coating is preferably up to 45% by weight, based on the total weight of the coating.

Diamond powder, by contrast, preferably has an average particle size of 2.5 to 90 μm, coating thickness is generally up to 1.5 mm, the proportion of diamond particles is up to 50% by weight, based on the total weight of the coating.

When the functional additive is conductivity carbon black, the average particle size is preferably in the range from 5 to 50 nm, layer thickness is preferably at least 200 nm and conductivity carbon black content is preferably up to 60% by weight, based on the total weight of the coating.

Microcapsules, which can be filled with phase change materials (PCMs), pharmaceutical, scent or dye agents for example, preferably have an average particle size of 2 to 90 μm, layer thickness is preferably at least 5 μm, the proportion of microcapsules is preferably up to 60% by weight, based on the total weight of the coating.

Of the functional additives which are antibacterial, nanosilver preferably has an average particle size of 20 nm or more, coating thickness is at least 200 nm, the nanosilver content is up to 1% by weight, based on the total weight of the coating. Zinc oxide as antibacterial additive preferably has an average particle size of 2 to 4 μm, layer thickness is preferably 5 μm or more, the proportion of zinc oxide in the coating is preferably up to 60% by weight, based on the total weight of the coating.

Absorbing additives preferably have an average particle size of 5 μm to 3 mm (activated carbon) or of 8 μm to 2 mm (superabsorbent polymers, SAP), layer thickness is preferably at least 5 μm (activated carbon) or up to 4 mm (SAP), and the proportion of absorbing additives is preferably up to 40% by weight, based on the total weight of the coating.

When ion exchangers are used as functional additives, the average particle size thereof is preferably in the range from 5 μm to 3 mm, coating thickness is preferably at least 10 μm and the proportion of ion exchanger is preferably up to 50% by weight, based on the total weight of the coating. It is also advantageous to use ceramic particles as functional additives at weight fractions up to 95%. In this case, particle size is 1-5 μm and layer thicknesses can be achieved in the range from 5 μm up to 5 mm. After sintering with simultaneous removal of the carrier body, hollow shaped articles such as hollow fibers, hollow wires or membranes are obtained, which can be used for different industrial purposes.

The process of the present invention is particularly useful for producing coatings containing liquid-filled microcapsules because this involves practically no shearing forces. Since spinneret pumps are not needed, it is also possible to produce coatings comprising particles having an abrasive effect. Spinneret die wear is avoided.

Solutions of cellulose in NMMO or in ionic liquids are particularly useful for producing coatings in the process of the present invention. These solutions largely preserve the structure of cellulose, i.e., the cellulose chains remain oriented. Therefore, drawing is no longer needed in the forming step to orient the molecules in the shaped article. This also explains the cause of the particularly high mechanical strength of shaped articles produced using these solutions. Even large amounts of addition agents are can be firmly anchored in the cellulose matrix without a corresponding reduction in overall strength. High fractions of crystalline cellulose are detectable in the ready-shaped article. By contrast, cellulose acetate, cellulose/cuprammonium and viscose solutions are true solutions in which the chain molecules are no longer bound to each other. The ready-shaped article contains large amorphous regions which first have to be drawn/oriented for higher strength to be achieved. The degree of crystallinity of cellulose can be determined for example via x-ray diffractometry as described in DIN EN 13925-1 to -3 “Non-destructive testing—x-ray diffractometry of polycrystalline and amorphous materials”.

In one advantageous embodiment of the invention, the container holding the polymer solution is temperature controlled, i.e., heated in general.

In one particularly advantageous embodiment of the process according to the invention the carrier material is fed to the coating space through a feed channel which is slidable in the exit direction of the core, which traverses the container space with the polymer solution and which separates the carrier material and the sheath material from each other before the coating operation. It is thus possible to vary the gap between the feed channel and the inside wall of the coating space. Specific gap width setting enables production of a layer having consistent thickness.

The carrier material and the sheath material in the coating space meet at a defined location which can be chosen as a function of the respective material properties, for example the solution properties, the viscosity or the content of addition agents. Preferably, the feed channel and the container space are disposed coaxially in relation to the exit openings.

Coating is advantageously preceded by sheath material layer thickness being adjusted, in particular by positioning the feed channel in the container space, by selecting the opening cross-section for the exit opening, by adjusting the withdrawal speed of the carrier material, by adjusting the exit speed of the sheath material into the coating space, and/or by selecting the polymer solution composition, which determines the flowability and the back-deformability of the polymer solution in the relaxation zone, and by the size and shape of the exit opening from the coating space.

In addition to coating solution viscosity and the applied pressure it is the opening cross-sections and the position of the feed channel which determine the efflux rate and the withdrawal speed which determines the contact time in the coating space under processing conditions.

A different pressure and/or different flow rates prevail in the coating space for the sheath material, the carrier material and/or both compared with the subsequent relaxation sector.

In one further embodiment of the process, the carrier material may be pretreated before it reaches the feed channel, or the carrier material may be pretreated in the feed channel.

An additional functional additive may be disposed on the core and be held or/and protected by the sheath material.

The functional additive may for example be brought onto the surface of the carrier material with a non-permanent binder and become anchored and covered by the sheath material in the course of coating. This procedure commends itself when the additives are not compatible with regard to the processing conditions, especially the processing solvent. In this case, any desired carrier material may be impregnated with nonpermanent systems of binder to imbibe for example process-sensitive additives which are subsequently stabilized by the additional construction of a permanent envelope of cellulose for example. The additives become anchored in the composite while contact time is short.

The carrier material may also have applied to it a shear-sensitive addition for example. The claimed process permits further coating of the carrier material without major shearing forces. The shear-sensitive addition is thus not stressed during the coating operation. When the ready-shaped article is exposed to a shearing force, the shear-sensitive addition can develop its effect of secreting colored particles for example.

In one advantageous embodiment of the invention, the sheath material layer thickness is made different on the top and bottom sides of the sheetlike carrier material used.

In one advantageous embodiment of the process according to the present invention, when sheetlike and pervious carrier materials are used, an underpressure is produced in a sub-region of said coating space to cause the sheath material to diffuse into the carrier material.

In one advantageous embodiment of the process according to the present invention, a coated carrier material is subsequently provided with a further coat. For this, it may more particularly be fed immediately subsequently into a further coating space where it is coated with a further sheath material supplied under elevated pressure.

The coated carrier material may also be subsequently fed to a dip bath and be provided with a further coat therein. Or the shaped article plus coating is subsequently subjected again, as a core, to a process in accordance with a process as described above.

The further coating may be for example a sheath layer of an alike or different polymer solution, for example likewise a cellulose layer, which forms a protective layer for the sheath layer containing functional additive and/or to smooth the surface.

The shaped article may more particularly be led through a dip bath containing glycerol or some other plasticizer. The plasticizer penetrates the cellulose material, and so the shaped article acquires a plasticizer content of up to 30%. This plasticizer content provides a certain degree of moisture and hence sleekness and bendability to the material.

Alternatively, the shaped article can be led through further dip baths in which the surface of the shaped article is roughened for example. These shaped articles are capable of having liquids, or oils for example, bind to and detach from the surface.

The coated shaped article may in further steps be treated according to processes known to a person skilled in the art, for example be led through a coagulation bath, temperature controlled, crimped and/or stretched.

In some embodiments of the invention, certain treatments or overcoats can be applied to a polymeric shaped article in order to confer additional properties such as for example stain resistance, water rejection, softer hand and moisture management properties. Examples of treatments and overcoats include Epic (available from Nextec Applications Inc., Vista, Calif.), ®Intera (available from Intera Technologies, Inc., Chattanooga, Tennessee) and Zonyl Fabric Protectors (available from DuPont Inc., Wilmington, Del.), ®Scotchgard.

The carrier material may be coated continuously or lotwise in batch operation.

Since the coating operation should ideally not be interrupted, it is advantageous to form shaped article intermediate products of defined length in succession. For this, the coated product is put on spindles. These are concurrently unwound in a subsequent step, so that the shaped parts each pass simultaneously through the washing sector at a reduced speed compared with the withdrawal speed.

The problem is also solved by a process for producing bristles by using process steps for producing a shaped article as described above to produce filaments which are processable in further conventional steps into bristles which can be processed into stiff brushes and soft brushes. In addition to further use as bristles in stiff brushes and soft brushes, many further fields of use are conceivable depending on the functional additive used. For example, fibers or filaments produced by this process can be processed alone or mixed with other fibers or filaments into textile fabrics.

Apparatus suitable for producing the shaped article of the present invention comprises a pressurizable container space for sheath material, a coating space having at least one variable feed opening each for the carrier material and for the sheath material and also at least one exit opening for delivering coated carrier material. The feed channel is disposed within the container space to feed carrier material into the thereby bounded coating space. The feed channel for the carrier material is positionally adjustable and engineered such that it can close the sheath material container space off from the coating space, but in particular can vary the feed opening for the sheath material into the coating space.

In one advantageous embodiment, the feed channel within the container space is movable, as a result of which especially an annular gap or a slotted gap is establishable between the feed channel and the inside wall of the container space.

Advantageously, the container and coating spaces are subdivided or subdividable by the feed channel (14; 14′) into separate sub-regions, especially such that different species and/or amounts of sheath materials are feedable to the carrier material via the separate sub-regions.

In one advantageous embodiment of the invention, an underpressure can be produced in one sub-region at least.

In one further advantageous embodiment of the apparatus according to the present invention, the gap opening for the exit of sheath material into the coating space is adjustable for every sub-region.

Advantageously, the feed channel is incarnated such that it is suitable for pretreating the carrier material, especially for application of corpuscles or liquids.

The invention further provides a shaped article consisting of at least one carrier material and at least one sheath material, obtainable via a process as described above. Sheath material layer thickness therein is generally between 200 nanometers and 5 millimeters.

The shaped article preferably contains at least one functional additive, in particular solid corpuscles having a size of 1 nanometer to 3 mm, especially at a weight fraction of up to 95% of the sheath material.

A particularly preferred embodiment of the invention relates to a shaped article, especially a filament, especially for fabrication of bristles, which contains at least 5% by weight, especially at least 10% by weight, more preferably at least 20% by weight and even more preferably at least 50% by weight of cellulose, the shaped article containing at least one functional additive incorporated into the shaped cellulose article. The functional additive comprises solid particles dispersed in the starting material of the shaped article, and/or a liquid emulsified in the starting material of the shaped article. The shaped article has a diameter of at least 0.01 mm, preferably between 0.01 mm and 3 mm, and more preferably between 0.1 mm and 1.0 mm.

In one embodiment, the shaped article is of cylindrical shape; that is, it has a surface that is bounded by parallel straight lines. It preferably has a rotationally symmetric configuration. However, the cross-sectional face may also have other shapes, so that the shaped article has a curved surface with edges and/or a curved surface of large surface area.

The shaped article in the dry state typically consists of at least 5% (weight fraction), preferably at least 20% and more preferably from 50% to 95% of cellulose. The cellulose preferably comes from the lyocell process, i.e., was obtained by a direct dissolving process in N-methylmorpholine N-oxide or in ionic liquids without derivatization.

The shaped article contains at least one functional additive in one particular embodiment. The shaped article may be laden with one or more functional additives at up to 95% weight percent of dry matter.

The functional additive is in a bound state in the polymer, i.e., in the cellulose for example. Functional additives incorporated in the shape-forming polymer, unlike particles only disposed at the surface of the shaped article, can be released/become useful at a uniform rate.

They also form a functional additive reservoir throughout the entire volume of the shaped article. The functionality of the shaped article, especially where a bristle filament is concerned, thus survives even surficial wear of the shaped article.

The functional additive comprises solid particles dispersed in the starting material of the shaped article, i.e., the carrier and/or sheath material, and/or a liquid emulsified in the starting material of the shaped article. The functional additive may comprise nanoparticles but also coarser structures, the diameter is approximately in the range from 1 nm to 3 mm.

The functional additive is finely distributed in the polymer solution, for example cellulose solution. The particles and/or droplets have diameters in the nm to mm range for example. Provided distribution of the functional additive in the carrier and/or sheath material is uniform, high loading with such additives can be realized while retaining sufficient formability.

The functional additive is preferably an addition agent having certain functional properties which transmit to the entire shaped article. Specifically at least one of the following properties of the shaped article is influenced thereby: tensile strength, flexural strength, stiffness, wear resistance, abrasivity, surface roughness, liquid imbibition capacity, friction behavior, odor, color, heat storage capacity, conductivity and antimicrobial performance.

In one preferred embodiment of the invention, the shaped article comprises a core composed of a carrier material and coated with at least one sheath material. The carrier material and/or at least one sheath material contain/contains predominantly cellulose therein. Preferably, at least one sheath material contains predominantly cellulose or the carrier material and at least one sheath material contain predominantly cellulose.

The shaped article can consist of a core having one layer of sheath material, but it may also have two or more layers. In this case, the sheath materials of the particular layers can differ and perform different functions. For example, the outermost layer can merely serve as a protective layer, which wears quickly when the shaped article is put to use, and which then exposes the underlying layer.

The carrier material for polymer-containing, especially cellulose-containing layers suitably comprises continuous filaments of mono- or multifilament, fibrous yarns, threads, metal strands or wires, glass fibers, but also sheets of textile-fabricated wovens and nonwovens which have a synthetic, metallurgical, mineral or natural provenience.

The core can also be a hollow fiber. Or a hollow core results following subsequent removal of the carrier material from the shaped article, for example by pyrrolysis or chemically.

The invention also provides for the use of shaped articles as described above for producing stiff brushes and/or soft brushes, and/or for polishing, cleaning, washing, roughening, smoothing, pressing down, sealing off and/or stripping off of surfaces and/or for removal and/or application of material atop surfaces.

The invention further provides bristles formed from a shaped article as described above and brushes comprising such bristles. Further fields of use are the production of sheet bodies such as bonded fibrous nonwoven webs, membranes, papers, coated foils and industrial textiles.

Carrier material diameter and sheath thickness preferably are approximately the same or are at least on the same order of magnitude.

The composite shaped articles of the present invention are particularly useful for industrial textiles and also as feedstock materials of construction for specific industrial applications.

The carrier material used can have a significant influence on the physical properties of the shaped article/filament, such as stability, flexibility, thermal or electrical conductivity. The carrier material can increase the tensile strength of the filament, which is advantageous when the filament produced is to be used in tension for example.

In one advantageous embodiment of the invention, the shaped article has a glycerol content of 0.01-30% by weight and preferably of 1-10% by weight. The glycerol acts as additional plasticizer in the sheath layer and ensures that the shaped article retains a certain degree of moisture. In this way, the shaped article retains its sleekness during prolonged storage times. Alternatively, polyethylene glycols can also be used.

The invention will now be elucidated with reference to drawings and examples, where

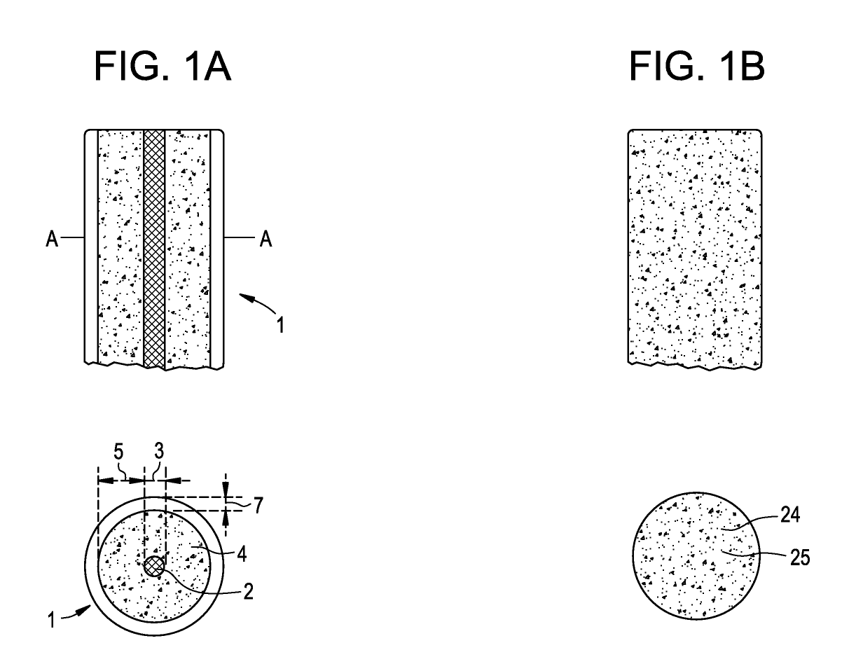

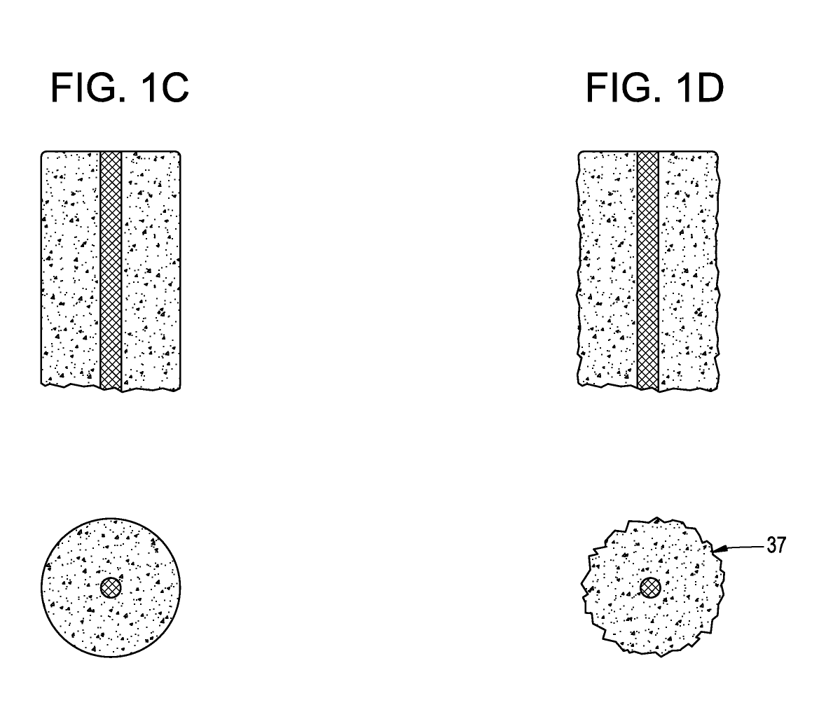

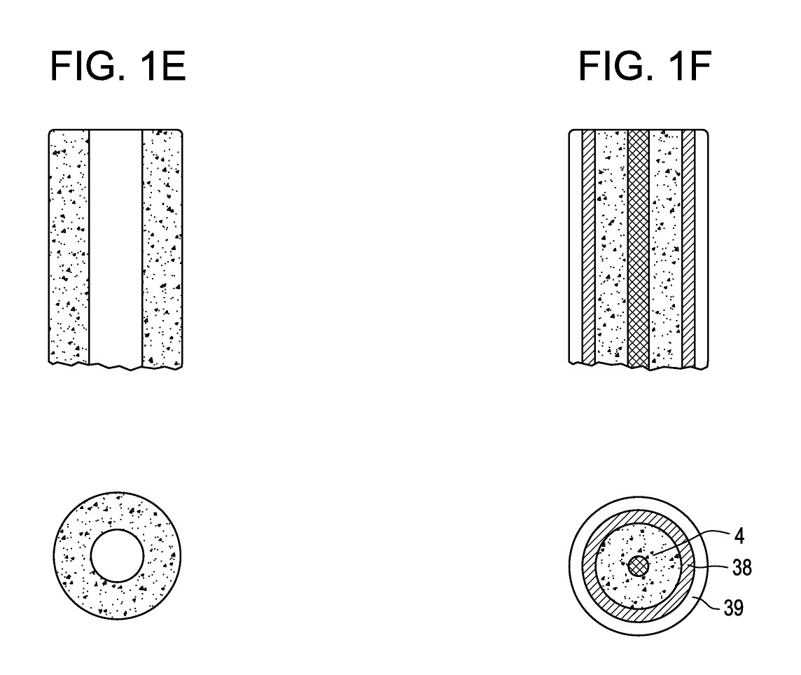

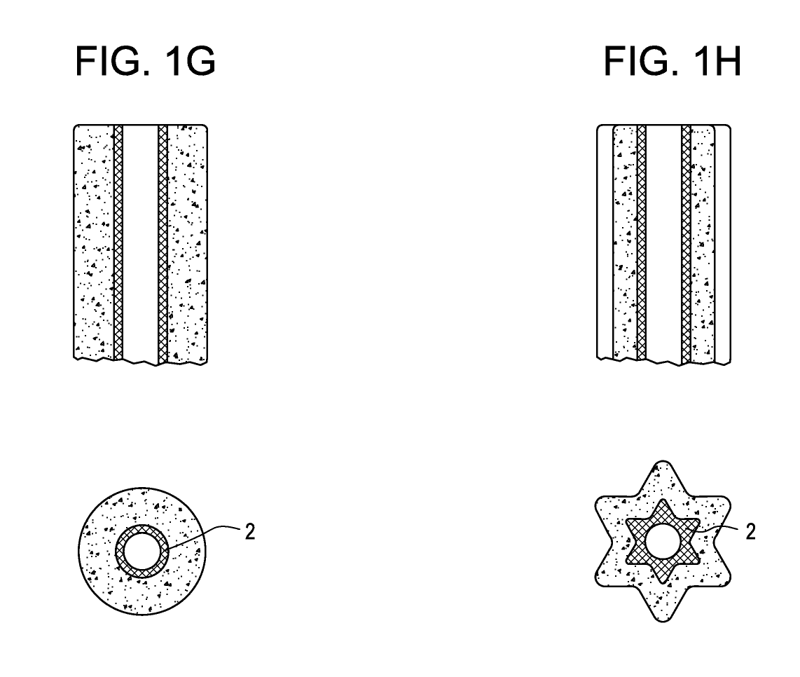

FIGS. 1a-1h show schematic sectional depictions of inventive shaped articles of differing construction;

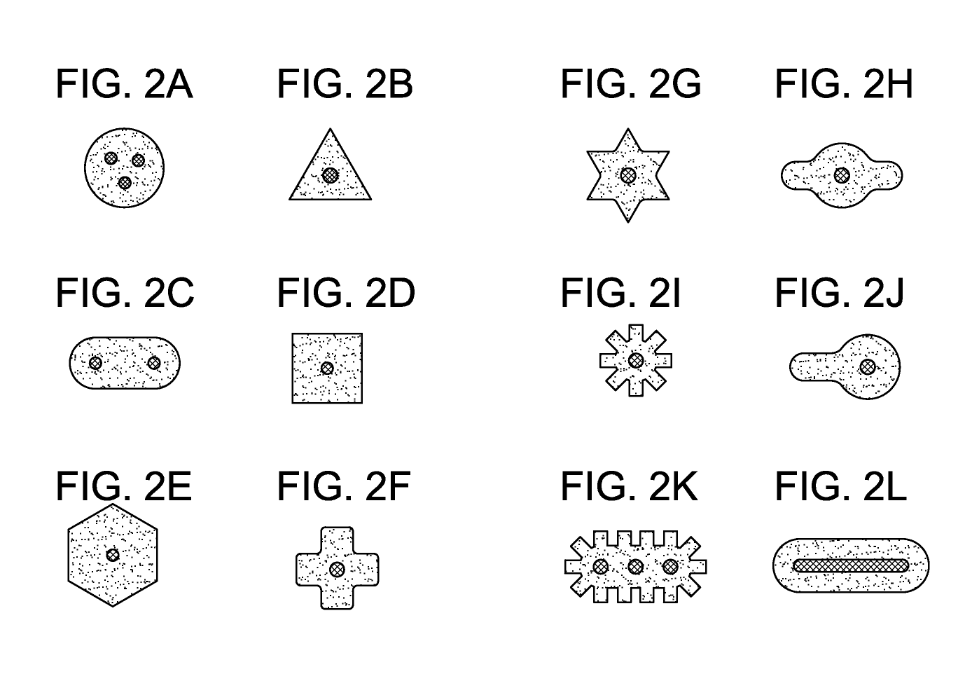

FIGS. 2a-2l show schematic sectional depictions of inventive shaped articles having different sectional face geometries;

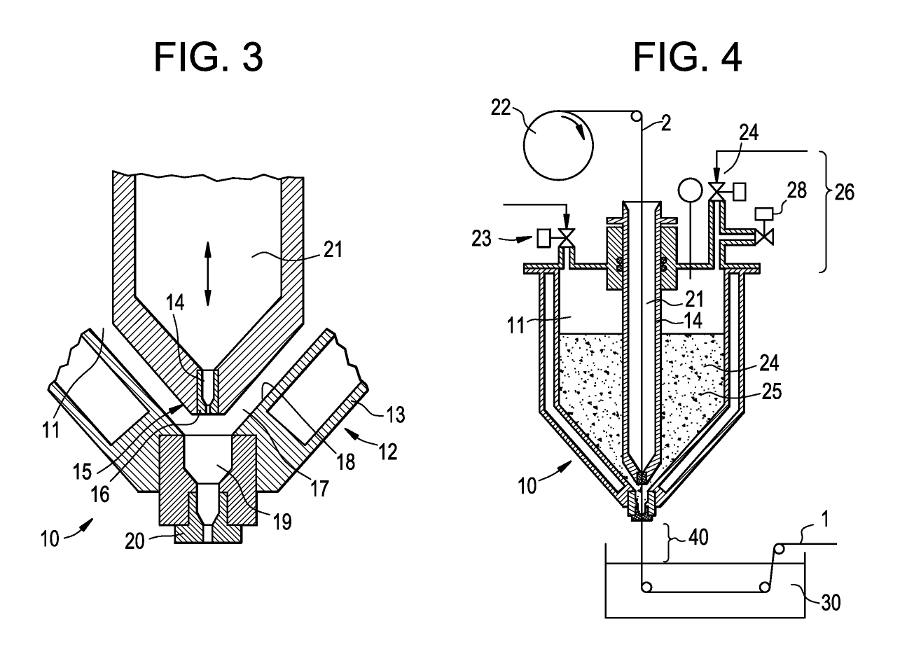

FIG. 3 shows a schematic depiction of apparatus suitable for the process of the present invention,

FIG. 4 shows a further schematic depiction of apparatus suitable for the process of the present invention;

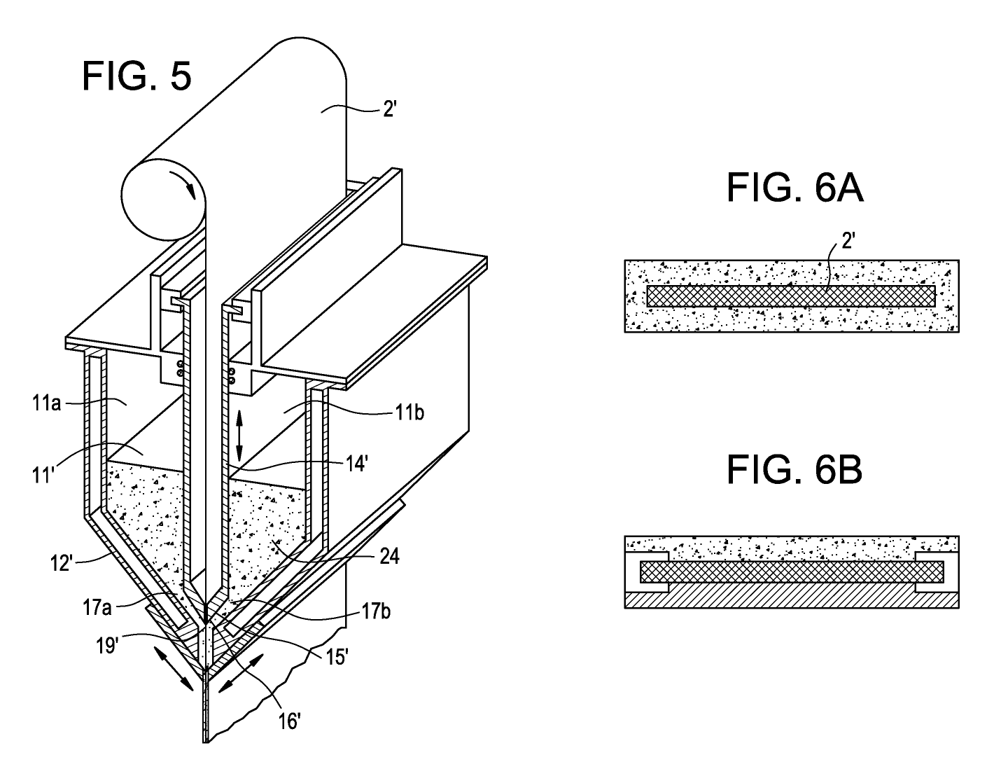

FIG. 5 shows a further schematic depiction of apparatus suitable for the process of the present invention;

FIGS. 6a-6b show schematic sectional depictions of inventive shaped articles having different sectional face geometries.

FIG. 1a shows schematic sectional depictions of a first example of an inventive shaped article. The upper illustration shows a longitudinal section, while the lower illustration shows a section along the sectional line AA. The shaped article 1 is of rotationally symmetrical configuration and has a likewise rotationally-symmetrically configured core of carrier material. The core 2 typically has a diameter 3 of 0.15 mm.

The core 2 is enveloped by a layer 4 of sheath material. This layer 4 contains functional additive. The layer 4 typically has a thickness 5 between 0.1 mm and 0.6 mm.

The shaped article la contains a final layer 7 of pure polymer produced from a polymer solution. This layer typically has a thickness of about 0.01 mm to 1.0 mm.

FIG. 1b similarly shows sectional images of a mono-filament where the polymer solution 24 incorporates a functional additive 25.

FIG. 1c similarly shows sectional images of a shaped article comprising a core 2 of carrier material and a sheath 4.

FIG. 1d similarly shows sectional images of a shaped article as in FIG. 1c following aftertreatment to texture its surface, and so the surface 37 is roughened (textured).

FIG. 1e similarly shows sectional images of a shaped article as in FIG. 1c following aftertreatment to remove the core of carrier material to produce a hollow article.

FIG. 1f similarly shows sectional images of a shaped article having multiple sheath layers 4, 38, 39, which contain different species or amounts of functional additives.

FIG. 1g similarly shows sectional images of a shaped article where a hollow fiber was used as carrier material 2.

FIG. 1h similarly shows sectional images of a shaped article where a carrier material 2 of textured sectional face geometry was used.

FIGS. 2a to 2l show schematic sectional depictions of further examples of inventive shaped articles having different sectional face geometries and a differing number of cores of carrier material.

Shaped articles of large surface area as in FIG. 1d or 2f, 2g, 2i or 2k are for example capable of retaining liquids, such as aqueous media or oils.

FIG. 3 shows a schematic depiction of apparatus 10 suitable for the process of the present invention.

The sheath material not explicitly shown in the illustration is stored in the container space 11 which is additionally maintained in gas atmosphere under overpressure. To temperature control the solution, the container 12 has a double-shell wall 13. A height-adjustable feed channel 14 is disposed in the middle of container 12 and contains at its lower, conically tapering end 15 an exit opening 16, for example in the form of a replaceable die-bore 16. The cone-shaped tubular tapering 15 is such that it combines with the inner container wall 18 to form a uniform annular gap 17 in the vertical direction. This makes it possible to use not only the applied container pressure but also the gap 17, which is alterable via the tube attitude, to regulate the exit rates of sheath material into the coating space and hence the applied layer thickness under defined contact conditions. The channel 14, which is open to the atmosphere at the downstream end 15, feeds the carrier material, not explicitly shown in this illustration, through the die 16 in the vertical direction in the form of a filament or yarn into the coating space or sheathing zone 19.

This is where the actual contact between carrier material and coating solution occurs. The coated carrier material is finally led away through the exit die 20.

Besides the additional means for setting the desired resulting layer thickness via the polymer solution composition, such as polymer content and additive content, and the geometry of the exit die 20, it is the withdrawal speed of the carrier strand which provides a means of influencing the thickness of the sheath layer to a significant extent.

The gap 17, the withdrawal speed of carrier material and the pressure in the coating space 19 are chosen so as to establish an equilibrium at which no coating solution can get into the channel space 21 and an uninterrupted sheathing of the carrier material takes place and can be dimensioned by the further exit die 20 from the coating space 19.

A vertical arrangement was chosen to obtain self-centering positioning of the carrier strand in the exit die 20, whence the coated carrier is fed via a relaxation sector into a regeneration bath which is not shown in the illustration.

FIG. 4 shows a further schematic depiction of inventive apparatus 10.

A carrier material 20 is fed from a roll 22 into the channel space 21 of the height-adjustable feed channel 14.

A polymer solution 24 can be filled into the container space 11 via a valve 23. The polymer solution 24, in which at least one functional additive 25 has been homogeneously distributed, is pressurized via a pressure module 26. The pressure module 26 comprises a pressure line 27 via which a gas, for example nitrogen, is directed into the container space, a control valve 28 and a pressure meter 29. The control valve 28 and the pressure meter 29 can be used to set and/or readjust a certain pressure or pressure profile. In addition, continuous replenishment of polymer solution under constant pressure into container space 11 can be realized.

The carrier material 2 coated with polymer solution 24 is fed via a relaxation sector 40 into a regeneration bath where a start is made on washing the solvent out of the polymer solution 24.

Diverting and guiding the coated carrier material 1 is only possible once a sufficiently stable skin of regenerated polymer has formed at the sheath surface.

It has transpired that, alternatively, a horizontal or upwardly directed guidance of coated carrier material with realizable thinner layer thicknesses, consolidated by spraying or drizzling with regenerating medium, will also provide a sufficiently stable polymeric skin which permits further guidance of coated material without coating stickiness or damage. However, care must be taken to ensure that regenerating medium does not get to the exit opening of the coated carrier material.

When the feed channel 14 shown in illustration 3l is configured as a channel having a rectangular cross section and slot-shaped exit openings 16 and 20, this apparatus can also be used to coat sheet-shaped bodies in the manner described, as shown in FIG. 5.

The sheetlike carrier material 2′ is supplied via a channel 14′ which likewise tapers conically at the downstream end 15′ into an outlet slot 16′ through which the carrier material 2′ passes into the coating zone 19′. The channel 14′ combines with the inside wall 18′ of container 12′ to form a slot-shaped gap 17a, 17b on both sides.

Depending on the incarnation of the container 12′ for receiving the coating solution 24, the carrier sheet can be coated with polymer solution on one side or both sides. FIG. 6a shows in schematic form the sectional image of a two-sidedly coated carrier material 2′.

When the container space 11′ is subdivided by the height-adjustable feed channel 14′ itself, different coatings of the front and reverse sides of the carrier material 2′ can be effected at one and the same time. Additionally, it is possible in the case of permeation-capable materials, such as textile sheets, to create a regulatable pressure difference before and behind the carrier material 2′ by underpressure application to a separated off solution space in the coating zone. As a result, the polymer solution can specifically penetrate into and through the woven fabric, as is advantageous to optimally connect the materials. Sub-spaces 11a, 11b of the coating space 11′ may to this end be equipped with separate pressure modules not explicitly depicted in the drawing.

Depending on the incarnation of the container for receiving the coating solution, the carrier sheet can be coated with polymer solution on one side or both sides. When the container space is subdivided by the height-adjustable channel itself, different coatings of the front and reverse sides of the carrier material can be effected at one and the same time, as shown in FIG. 6b by way of example.

The channel space 21 of the feed channel 14 can also be appropriately adapted to enable any desired pretreatment of the carrier material to be done immediately before coating.

To use sensitive or process-incompatible additive components the carrier material may be powdered therewith or impregnated with a suspension or emulsion which contains the additions. Even simple non-permanent, e.g., water-soluble, systems of binder are suitable in order that, for example, metallic powders or other solid particles may be prefixed on and in the carrier material and permanently enclosed via a subsequent sheathing with a polymer solution which may also contain further additions. The advantages resulting therefrom reside in an extremely short time for additive components to be in contact with the polymer solution under processing conditions, such as the processing temperature, without additional stress due to shearing. A layerwise positioning of mutually interacting additive components for example in the carrier material and in the sheathing layer and optionally further addable layers gives vistas to possible uses for the production of polymeric electronic components for example. Moreover, metallic conductors can be used as the carrier material itself. In this case, there is the additional possibility, in line with DE 10 2004 052120, to achieve covalent attachment for specifically very thin cellulose layers in the nanometer range by additionally activating the carrier material surface. Astonishingly, the relaxation behavior of polymer-containing coating solution in a relaxation sector, for example an air gap of defined choosable extent, and the subsequent deswelling operations of shaped article aftertreatment for solvent removal and drying were found to cause the carrier material to become firmly enclosed by the polymeric sheath layer which forms. The composite obtained has high mechanical binding forces between the carrier material surface and the polymer layer.

It was additionally found that the use of a carrier material to take up the withdrawal forces of solution jet deformation makes it possible for even very labile polymeric solutions having very high fractions of extraneous matter to give stable forming at shape-conferring speeds which are a multiple of the jet stretch speed, which is limited by the deformability of the solution.

One particular embodiment of the process according to the present invention may contain the following steps: A first processing step comprises forming three shaped articles 1 in apparatus 10 for producing shaped articles. The withdrawal speed is typically 20 m/min. The shaped articles 1 are led through an aftertreatment zone, for example a regeneration bath, and wound up on spindles.

In a subsequent processing step, the solvent is washed out in a wash bath. Since the washing speed is only 2 m/min, 30 shaped articles 1 are led through the wash bath in a parallel arrangement.

The shaped articles may be subsequently led through further neutralization baths not explicitly depicted.

Finally, the shaped articles 1 are led through a finish bath and a drying oven.

A multifold arrangement of inventive apparatuses 1 makes it possible for layers to be constructed in succession on the same carrier or for further carrier materials to be applied. It is possible in each case for sheath materials of different compositions to be used or layers of different thicknesses to be produced. The layers can also be fixed using a subsequent coating.

Coating a carrier material to a desired layer thickness can be achieved through repeated coating and passage through a regeneration bath. Each coating step will on its own apply only a relatively thin layer, from which the solvent can be dissolved out practically completely in the subsequent regeneration bath 30.

The coatings thus produced have very good adherence to carrier material 2.

The exemplary embodiments which follow serve to illustrate the invention. Percentages are by weight, unless otherwise stated or directly apparent from the context.

### EXAMPLE 1

A quantity of 16 646 g of a 60% aqueous solution of N-methylmorpholine N-oxide (NMMO) was admixed with 580 g of pulp having an average degree of polymerization of 600 and 3 g of propyl gallate in a stirred dissolving vessel to prepare a cellulose solution having a resulting solids content of 4%. It was subsequently transferred into the coating apparatus, which was heated at a temperature of 85° C.

A 33%/67% polyester/cotton metric count 24 yarn was used untreated as carrier material.

It was possible to spin a uniform monofilament having a strand diameter of 500 μm at a container admission pressure of 2 bar, a withdrawal speed of 5 m/min and an exit die diameter of 3 mm. Changing the exit die diameter to 1.5 mm while keeping the conditions otherwise the same, a thread diameter of 300 μm was realized. By changing the annular gap 17 using the height-adjustable feed channel 14 it was possible to vary the layer thickness and to increase the withdrawal speed. A consistent final diameter of 400 μm was achieved for the coated strand at a withdrawal speed of 20 m/min.

The coated carrier material exited from exit die 20 into a relaxation sector 2 to 50 cm in length, for example an air gap, without influence on the sheath layer formed and spinning stability. This was followed by vertical entry into a regeneration bath of deionized water with low solvent content. A change of direction device below the liquid surface, which can be embodied to be fixed or as roller, was used to guide the coated strand back out of the bath before it was bundled using a withdrawal device, subsequent wash baths and a winding device into bundles which were subsequently dried under mechanical pretension.

The monofilament thus produced acquired high stiffness and strength, making it useful for polishing applications. The cellulose sheathing applied has high mechanical bonding to the carrier strand.

### EXAMPLE 2

Example 1 was repeated except that a cellulose solution having a higher cellulose content of 11% was prepared and used as coating solution. The coating apparatus was operated at a temperature of 95° C. The diameter of exit die 20 was 1.5 mm and that of strand exit die 16 was 0.5 mm. The carrier material used was an 83 dtex 36 filament ecru textured polyester yarn without pre-treatment.

A composite filament having a consistent diameter of 200 μm was obtained at a container admission pressure of 3.4 bar under nitrogen blanketing and a withdrawal speed of 20 m/min. Aftertreatment was as in example 1. The material obtained is useful for applications in the stiff and soft brush industry.

### EXAMPLE 3

A 60% aqueous solution of N-methylmorpholine N-oxide was admixed with mechanically comminuted pulp having an average degree of polymerization of 600 in an amount to produce therefrom a cellulose solution having a dissolved cellulose content of 10.5% in NMMO monohydrate. In addition, during the dissolving process, a 20% quantity of zinc oxide based on cellulose was added as functional additive and the mixture was converted by water removal under shearing in vacuo at rising processing temperature up to 94° C. into the solution state of cellulose. The cellulose solution thus obtained, laden with zinc oxide, was transferred into the coating device and the coating was carried out under the same conditions as in example 3 on the same carrier material. Aftertreatment was done as in example 1. The monofilament obtained is of white color, has additional antibacterial properties and an abrasive effect and is suitable for hygiene applications in the dental sector.

### EXAMPLE 4

A quantity of 18 207 g of 60% aqueous N-methylmorpholine

N-oxide was admixed with 1400 g of mechanically comminuted pulp having an average degree of polymerization DP of 600 together with 8.8 g of propyl gallate and also, as functional additive, 560 g of silicon carbide having a fractionated granule size of 120 μm. This mixture was converted into the dissolved state of cellulose in a stirred dissolving vessel by shearing in vacuo and under increasing processing temperature up to 94° C. by distilling off about 5700 g of water.

The solution obtained contained 9.6% of dissolved cellulose and also 3.8% of silicon carbide in homogeneous distribution. This solution was transferred into the coating device which was heated to 90° C. An 80 tex 120 filament lyocell multifilament yarn without pretreatment was fed as coating carrier into the coating space 19 through the strand exit die 16 having a hole diameter of 1 mm. A container pressure of 4.2 bar under nitrogen blanketing and an exit die diameter 20 of 3 mm coupled with a withdrawal speed of 15 m/min gave a coated monofilament having a final diameter of 850 μm. Aftertreatment was done as in example 1. The material produced is particularly useful as very abrasive sanding bristle for a variety of surface-machining operations.

### EXAMPLE 5

7573 g of 60% aqueous N-methylmorpholine N-oxide were admixed with 250 g of mechanically comminuted pulp having an average degree of polymerization DP of 600 together with 3 g of propyl gallate and also 4510 g of ceramic metal oxide powders. This mixture was converted into the dissolved state of cellulose in a stirred dissolving vessel by shearing in vacuo and under increasing processing temperature up to 94° C. The highly doped polymeric solution having a resulting solids content of 47.6% in the solution was transferred into the coating apparatus, which was heated at 80° C.

This composition was used at various settings to obtain different composite diameters, which are summarized in the table below:

| Container | Carrier | Withdrawal | Die diameter | Strand |
|---|---|---|---|---|
| pressure | material | speed | 16/20 in mm | thickness |
| 1.1 bar | 10 tex 50 | 10 m/min | 0.5/1.5 mm | 320 μm |
| | filament | | | |
| | lyocell | | | |
| 1.3 bar | 10 tex 50 | 10 m/min | 0.5/1.5 mm | 600 μm |
| | filament | | | |
| | lyocell | | | |
| 1.5 bar | 80 tex 120 | 20 m/min | 1.0/1.5 mm | 800 μm |
| | filament | | | |
| | lyocell | | | |

By changing the annular gap 17 by means of the height-adjustable feed channel 14, the conically shaped downstream end 15 of which at one and the same time, by virtue of its positioning, bounds the annular gap 17 and serves as shut-off means in the event of system upset, it is possible to regulate the polymer solution influx into the coating space 19 and hence the layer thickness applied.

### EXAMPLE 6

A quantity of 16 130 g of a 60% aqueous solution of N-methylmorpholine N-oxide was admixed with 1237 g of mechanically comminuted pulp having an average degree of polymerization DP of 600 and also with 7.8 g of propyl gallate and 412 g of diamond powder 3 -6 μm in particle size. This mixture was converted into the dissolved state of cellulose in a stirred dissolving vessel by shearing in vacuo and under increasing processing temperature up to 94° C. by distilling off about 5100 g of water. The solution obtained contained 9.6% of dissolved cellulose and also 3.2% of diamond particles in homogeneous distribution.

This solution was transferred into the container space 11 of coating device 10, which was heated at 95° C. Die 16 was closed. A triple die having a bore diameter of 3×1 mm was used as die 20. At a container pressure of 6.5 bar, filaments having a consistent final diameter of 150 μm were spinnable at a withdrawal speed of 30 m/min.

Owing to the abrasive addition of particles like in example 4 also, conventional forming of such polymeric solutions into strands by using conveying and metering displacement pumps, primarily toothed gear pumps, is not possible with these ingredients. However, the forming and coating device presented herein also enables continuous industrial processing of such additive-laden polymer solutions.

For example, continuous fabrication is possible without interrupting the polymer solution discharge by replenishing with coating solution via a pressure lock.

### EXAMPLE 7

A lyocell pulp (eucalyptus sulfite pulp, cuoxam DP:525) was beaten in water at a liquor ratio of 20:1 using an Ultra-Turrax® type stirrer and dewatered to 35% by mass of solids by pressing off.

Dispersing 71.4 g of press-moist cellulose in 321.4 g of 1-ethyl-3-methylimidazolium acetate containing 30% by mass of water and 0.9 g of NaOH gave a homogeneous suspension which was transferred into a vertical kneader. This was followed by shearing at a slowly ascending temperature from 75° C. to 115° C. and a decreasing pressure from 800 to 15 mbar and water removal to obtain a microscopically homogeneous cellulose solution 10% by mass in strength. This solution is then further processed similarly to example 2.

### EXAMPLE 8

A lyocell pulp (eucalyptus sulfite pulp, cuoxam DP:556) was beaten in water in a liquor ratio of 20:1 and pressed off to a moisture content of 60% by mass. 43.8 g of this press-moist cellulose were dispersed in 475 g of 1-butyl-3-methylimidazolium chloride containing 30% by mass of water and stabilizer additions (0.2% of NaOH, 0.02% of propyl gallate, based on the polymer solution to be produced) to obtain 520 g of a homogeneous suspension which is introduced into a vertical kneader and converted, by shearing, increasing temperature from 80 to 125° C. and decreasing pressure from 800 to 20 mbar and water removal, into a microscopically homogeneous cellulose solution 5% by mass in strength. This solution is then further processed similarly to example 1.

### EXAMPLE 9

Bombyx mori silk fibroin cut to 3-5 mm lengths is dispersed in water, beaten in a liquor ratio of 20:1 and allowed to swell for 12 h. A slight press-off is carried out to dewater to 10% by mass of fibroin. Dispersing 105 g of press-moist silk fibroin in 74.375 g of 80% aqueous solution of 1-butyl-3-methylimidazolium acetate (BMIMAc) to which 0.5% by mass of propyl gallate/sodium hydroxide has previously been added as stabilizer gives 179.375 g of a slurry which, after introduction into a kneader, is converted, by vigorous shearing, a temperature of 80-90° C. and decreasing pressure of 850 to 5 mbar and complete removal of water, into 70 g of a homogeneous solution. The dissolving time is 160 min. The solution obtained is filled into the container 2 and further processed similarly to example 1.

### EXAMPLE 10

7.0 g of finely ground maize zein are dispersed in water and filtered off. To 78.75 g of an 80% aqueous solution of 1-butyl-3-methylimidazolium chloride (BMIMCl) to which 0.5% by mass of propyl gallate/sodium hydroxide has previously been added as stabilizer, the moist protein is added portionwise under agitation to form a homogeneous suspension. This suspension, after introduction into a kneader, is converted, by vigorous shearing, a temperature of 80 to 90° C. and decreasing pressure of 850 to 6 mbar and complete removal of water, into 70 g of a homogeneous solution. The dissolving time is 120 min. The solution obtained is filled into the container 12 and further processed similarly to example 1.

### EXAMPLE 11

A 7.5% (by mass) PAN homopolymer solution in 1-butyl-3-methylimidazolium chloride (BMIMCl) was transferred at 95° C. into the coating apparatus, which was likewise heated at a temperature of 95° C. A 67%/33% polyester/cotton metric count 24 yarn was used untreated as carrier material. It was possible to obtain a uniform monofilament having a final strand diameter of 300 μm at a container admission pressure of 2 bar, a withdrawal speed of 6 m/min and an exit die diameter 20 of 1.5 mm. By changing the annular gap 17 using the height-adjustable feed channel 14 it was possible to vary the layer thickness and to increase the withdrawal speed. A consistent final diameter of 400 μm was achieved for the coated strand at a withdrawal speed of 25 m/min.

This was followed by vertical entry into an aqueous BMIMCl-containing (5% by mass) coagulation bath. The shaped article was subsequently washed solvent-free, dried at 100° C. on heated godets and wound up as filament.

### EXAMPLE 12

A spinning solution consisting of 4.6% of PAN homopolymer, 23.1% of alumina particles (CT 3000 SG, from Alcoa with 0.7 μm corpuscle size) and 72.3% of BMIMCl and having a temperature of 95° C. was introduced into the coating apparatus. The carrier was a 130 μm-thick PAN monofilament without spin finish. The annular gap 17 was adjusted to the withdrawal speed of 30 m/min via the height-adjustable feed channel 17. In this way, a total filament 200 μm in diameter was obtained after wash-off and drying. Sintering the Al₂O₃-coated monofilament obtained at 1400° C. to burn out the PAN phases and sintering the alumina particles gave porous hollow fibers 180 μm in outer diameter and 22 μm in wall thickness.

### EXAMPLE 13

A 12.5% (by mass) PAN copolymer solution (Dolan type copolymer) in DMF was transferred into the coating apparatus at 25° C. The carrier material used was a 150 μm-thick cellulose monofilament obtained using lyocell technology. At a container admission pressure of 1 bar, a withdrawal speed of 30 m/min and an exit die diameter 20 of 1000 μm it was possible to obtain a uniform monofilament having a final strand diameter of 250 μm. The DMF solvent was removed from the coating by subjecting the vertically exiting filament to a laminar flow of hot air at 145° C. across a sector 2 meters in length.

### EXAMPLE 14

A 6% PAN copolymer solution (Dolan type copolymer) in 1-ethyl-3-methylimidazolium nitrate was applied at 100° C. to the coating apparatus wherein exit die 20 into the relaxation sector was a slot die of 500 μm slot width. A polyester foam 100 μm in thickness was used as carrier foil in that it was sheathed with the copolymer solution. A 5 m/min withdrawal produced, after wash-off and drying, a PAN-coated compound foil of 125 μm. Raising the withdrawal speed of the foil to 20 m/min led to a foil thickness of 113 μm.

### EXAMPLE 15

Example 14 was repeated except that a 10% PAN copolymer solution DMAC at 30° C. was used as coating solution. At a withdrawal speed of 15 m/min, the carrier foil was coated with a PAN layer 15 μm in thickness by adjusting the slot 20. Reducing the withdrawal speed to 8 m/min resulted in a layer thickness of 22 μm. The DMAC solvent was removed in each case from the coating by subjecting the vertically emerging in countercurrent bicomponent foil to a laminar flow of hot air at 155° C. across a sector 2 meters in length.

### EXAMPLE 16

Example 14 was repeated except that a spunbonded polyester web having a basis weight of 60 g/m² was coated. A withdrawal speed of 8 (15) m/min produced a PAN-laminated polyester web of 130 g/m².

### EXAMPLE 17

A 13% (by mass) PVA solution in water was prepared and introduced at 25° C. into the coating apparatus. The hole die 16 in the coating device 10 had a diameter of 1 mm. The strand to be coated consisted of a multifilament of 150 individual fibers of polyester with a total linear density of 100 tex. The withdrawal speed was 15 m/min. The PVA solution was fed at a pressure of 0.5 bar into the coating space 19 onto the strand to be coated. After exiting from the die 20 2 mm in diameter and passing through an air gap of 10 cm, the PVA/water solution layer was precipitated in a coagulation bath containing 400 g/l of sodium sulfate, washed with dilute sodium sulfate solution and then air dried at 60° C. and heat-set at 180° C. The proportion of PVA on the coated strand was 25%.

### EXAMPLE 18

A 14% (by mass) PVA solution in a 3.5/l water/ethanol mixture was prepared and introduced at 25° C. into the coating apparatus. The hole die 16 in the coating device 10 had a diameter of 0.5 mm. The strand to be coated consisted of a multifilament of 80 individual fibers of polyester with a total linear density of 50 tex. The withdrawal speed was 30 m/min. The PVA solution was fed at a pressure of 0.5 bar into the coating space 19 onto the strand to be coated. After exiting from the die 20 1.0 mm in diameter, the coated system was dried countercurrently with a laminar air flow at a temperature of 80° C.

### EXAMPLE 19

Example 12 was repeated except that the PVA solution contained 6% (by mass) of PVA and additionally 15.5% of conductivity carbon black. The dried strands had a specific electrical resistivity of 2 ohms/cm and hence had marked charge-dissipating properties.

The exemplary embodiments recited herein are only a small selection of possible uses for the coating process presented. As mentioned, various components can either be directly introduced into the polymer solution and applied to and fixed on any desired carrier by a coating, or be positioned on the carrier by a pretreatment and then be permanently anchored by sheathing with a polymer solution from which the polymer is regenerated. The possibility of multiple coating of carrier materials in directly successive operations with differently functionalized polymer solutions, the components of which can interact with each other, opens up further fields of use.

1-23. (canceled)

24. A process for producing a shaped article having a polymeric coating, said process comprising the steps of
a) dissolving polymers in a solvent in a direct dissolving process to form a polymer solution from which the polymeric coating is produced,
b) coating the shaped article in a coating space by forced wetting in variable pressure and flow equilibrium with the polymer solution which is fed through a predefined gap at defined pressure into the coating space to form a provisional layer,
c) feeding the shaped article obtained in step b) through a relaxation sector of defined length in which the polymers in the provisional layer align and undergo viscoelastic relaxation to form a final low-stress layer, and
d) removing the solvent from the final, low-stress layer,
wherein the polymeric coating thickness is regulated by adjusting the withdrawal of the shaped article relative to the speed at which the polymer solution flows through the predefined gap into the coating space, and adjusting the gap size on entry of the polymer solution to the coating space and on exit of the coated shaped article into the relaxation sector.

25. The process as claimed in claim 24, wherein the length of said relaxation sector is at least 5 mm at defined ambient conditions of pressure, temperature, moisture and atmospheric composition to form the relaxed coating.

26. A process as claimed in claim 24, wherein the polymer solution is produced using directly soluble natural, synthetic or biotechnologically produced polymers.

27. A process as claimed in claim 24, wherein the polymer solution comprises a cellulose solution obtained in the direct dissolving process in solvent selected from N-methylmorpholine N-oxide or ionic liquids without derivatization.

28. A process as claimed in claim 24, wherein the solvent used for producing the polymer solution comprises polar solvents, salts, acids, ammonia, organic solvents, tertiary amine oxides, apolar solvents, ether, or ionic liquids.

29. A process as claimed in claim 28, wherein the polar solvent is water, alcohol, acetone, acetonitrile, dimethyl sulfoxide or glycerol; the salt is LiCl or sodium thiocyanate; the acid is acetic acid; the organic solvent is dimethylformamide, dimethylacetamide or N-methylpyrrolidone; the tertiary amine oxide is NMMNO; the apolar solvent is a short-chain hydrocarbon; and the ionic liquid is alkylimidazolium chloride or acetate or nitrate.

30. A process as claimed in claim 29, wherein the short-chain hydrocarbon is petroleum.

31. A process as claimed in claim 24, wherein the polymer solution contains at least one functional additive and the functional additive is in liquid or solid form.

32. A process as claimed in claim 31, wherein the functional additive is present at a weight fraction of up to 95% of the coating and the functional additive has a droplet or particle size of between 1 nm and 3 mm.

33. A process as claimed in claim 24, wherein the shaped article is fed to the coating space through a feed channel which is slidable in the exit direction of the core and which separates the shaped article and the polymer solution from each other before the coating operation and wherein the width of the gap between said feed channel and the inside wall of said coating space is adjusted thereby.

34. A process as claimed in claim 24, wherein the coating thickness is adjusted by adjusting the pressure in a container, by positioning a feed channel into said coating space, by choosing the opening cross-section of an outlet opening, by adjusting the withdrawal speed of the shaped article, by adjusting the exit speed of polymer solution into the coating space, and/or by choosing the polymer solution composition.

35. A process as claimed in claim 24, said process further comprising pretreating the shaped article in a feed channel.

36. A process as claimed in claim 35, wherein said pretreating comprises endowing the shaped article with abrasive corpuscles.

37. A process as claimed in claim 24, wherein said shaped article is a sheet body or pervious article having top and bottom sides and
a) the sheet: body is coated on one side or on both sides, and/or
b) the layer thickness and/or the coating composition is optionally made different on the top and bottom sides of the shaped article, and/or
c) an underpressure is produced in a sub-region of said coating space to cause the polymer solution to penetrate into/through the shaped article.

38. A shaped article with polymeric coating formed by a process as defined in claim 24.

39. A shaped article as claimed in claim 38, wherein the coating has a layer thickness in the range from 200 nm to 5 mm.

40. A shaped article as claimed in claim 38, wherein the coating contains at least one functional additive, and said functional additive comprises solid particles which were dispersed in a starting material of the shaped article, and/or a liquid which was emulsified in the starting material of the shaped article, and the droplet/particle size is in the range from 1 nanometer to 3 mm.

41. A shaped article as claimed in claim 40, wherein the functional additive is present at a weight fraction of up to 95% of the coating.

42. A shaped article as claimed in claim 40, wherein the functional additive comprises one or more members of the group consisting of carbides, metal oxides, diamond, cubic boron nitride, hard metals, scent and/or care chemicals, oils; friction-reducing pigments, color pigments, conductive substances or antimicrobial substances.

43. A shaped article as claimed in claim 42, wherein the carbide is silicon carbide or boron carbide; the metal oxide is alumina, corundum, yttria or ceria; the oil is paraffin;
the friction-reducing pigment is Teflon, molybdenum sulfide or graphite; the color pigment is TiO2; the conductive substance is carbon black, carbon nanofibers or nanotubes, aluminum, copper, or silver; the antimicrobial substance is a metal or metal compound.

44. A shaped article as claimed in claim 43, wherein the metal or metal compound is silver, a silver compound, zinc, a zinc compound, copper or a copper compound.

45. A shaped article as claimed in claim 38, wherein said coating contains at least 5% by weight of cellulose and the coating further contains at least one functional additive embedded in the cellulose, said functional additive comprising solid particles dispersed in a starting material of the shaped article and/or a liquid emulsified in a starting material of the shaped article, said shaped article having a diameter of at least 0.01 mm.

46. A shaped article as claimed in claim 45, wherein said coating contains more than 50% by weight of cellulose, and said shaped article has a diameter of between 0.01 mm and 3 mm.

47. Bristles, stiff brushes, soft brushes or sheet bodies comprising a shaped article as claimed in claim 38.

48. Bristles, stiff brushes, soft brushes or sheet bodies as claimed in claim 47, wherein said sheet bodies are bonded fibrous nonwoven webs, membranes, papers, coated foils or industrial textiles.
